(19) United States
(12) Patent Application Publication
(10) Pub. No.: US 2005/0008188 A1
(43) Pub. Date: Jan. 13, 2005

(54) Loudspeaker with a double spider centering system

(76) Inventor: Michael Harris, Cardiff (GB)

Correspondence Address: Gauthier & Connors LLP, Suite 3300, 225 Franklin Street, Boston, MA, 02110, US

(21) Appl. No.: 10/846,848

(22) Filed: May 14, 2004

(30) Foreign Application Priority Data
May 14, 2003 (DE) 103 21 690.1

(51) Int. Cl. H04R 1/00; H04R 9/06; H04R 11/02

(52) U.S. Cl. 381/404; 381/398; 381/400; 381/423

(57) ABSTRACT

A loudspeaker includes a frame, a diaphragm disposed in the frame, a motor system for the diaphragm including a magnet system attached to the frame and a voice coil system attached to the diaphragm. A surround is disposed in a relatively non-supporting and non-stressing relationship to the diaphragm and the frame. A centering system is located in the frame for the cone and/or the voice coil and provides support therefore. The centering system includes at least two identical spiders arranged back-to-back in axial distance from each other.

### 1. CLAIM OF PRIORITY

This patent application claims priority to German application DE 103 21 690.1 filed on May 14, 2003.

### 2. FIELD OF THE INVENTION

The present invention relates to the field of loudspeakers, and in particular to a centering system for loudspeakers.

### 3. RELATED ART

Various designs for the centering systems and in particular centering spiders (including centering discs) for a diaphragm (e.g., cone) of a loudspeaker have been proposed but none of these designs has proven fully satisfactory. For example, U.S. Pat. No. 3,767,004 discloses a loudspeaker with a centering system in a frame for a voice coil and an attached cone providing spaced coaxial support therefore. The centering system includes two spiders arranged in axial distance from each other. The centering system reduces the off-axis voice coil system movement.

However, there is a need for an improved centering system, particularly in view of the acoustic properties of the loudspeaker.

### SUMMARY

A centering system is provided for the diaphragm (e.g., cone) of a loudspeaker. The centering system employs a double spider design having two centering spiders (or centering discs) arranged back-to-back in an axial distance from each other.

The back-to-back arranged spiders may be configured and arranged as two annular elements with identical waveform patterns arranged in phase opposition. That is, if the pattern of one spider goes up the pattern of the other goes down and vice versa. The spiders are preferably identical.

The double spider arrangement improves the harmonic distortion due to the back-to-back configuration of the spiders. The double spider design evens out the difference in positive to negative excursion nonlinearities and reduces the DC bias associated with most loudspeakers due to suspension creep and component aging effect, which cause the suspension to relax when exercised at high excursions for long times and when tested at high temperature and high relative humidities.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### DESCRIPTION OF THE DRAWING

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a vertical sectional view of a loudspeaker that includes a centering system;

FIG. 2 is a front view of the loudspeaker of FIG. 1;

FIG. 3 is a vertical sectional view of a centering system with two parallel spiders attached to the voice coil carrier;

FIG. 4 is a vertical sectional view of a centering system with two parallel spiders attached to the voice coil and the diaphragm;

FIG. 5 is a diagram showing the 2nd and 3rd harmonic distortions for a loudspeaker with a single spider when considering only the loudspeakers non-linearities from the suspension compliance, spider and surround;

FIG. 6 is a diagram showing the 2nd and 3rd harmonic distortions for a loudspeaker with a double spider when considering only the loudspeakers non-linearities from the suspension compliance, spider and surround; and

FIG. 7 is a sectional view of a flat loudspeaker that includes a centering system.

### DETAILED DESCRIPTION

FIG. 1 is a vertical sectional view of a loudspeaker that includes a basket-like shaped metal chassis 100 serving as a frame. A magnet system 101 is attached to a rear end of the metal chassis 100 by bolts 102. The magnet system 101 has two neodymium permanent magnets 103, 104 connected by a soft-magnetic connector piece 105 and secured to a soft-magnetic core 106 of a soft-magnetic shell pot 107, spaced to provide a flux gap 108. The gap 108 extends through the rear end of the chassis 100.

A voice coil system 110 extends into the gap 108 and is secured to a cone-shaped aluminum diaphragm 111 in driving relation thereto. The voice coil system 110 comprises a voice coil carrier 112 and a flat wire voice coil 113. Spaced coaxial centering spiders 114 and 115 to support the voice coil system 110, and are spaced and held by a spacer ring 116 that is fixed (e.g. by an adhesive) to the metal chassis 100. In particular, the spacer ring 116 has two end faces each attached to the periphery of the spider 114 or 115, respectively.

A surround 120 is attached to the front end of the metal chassis 100 and to the periphery of the diaphragm 111 by adhesive. The surround 120 is provided in the form of an arched ring made of rubber (e.g., natural or synthetic rubber, including Neoprene, or of a silicone rubber or of a fluoro-elastomer). Silicone rubber has good qualities of extendibility or stretch, and recovery, and long life. The surround 120 has the desired damping qualities and flexibility, particularly when the voice coil system 110 is caused to oscillate. The surround 120 is relatively light and thin and, by its damping properties, damps out reflections from the metal chassis that may cause standing waves and undesired resonances.

The spiders 114 and 115 may have high radial rigidity and high axial flexibility, such that the surround 120 provides almost no supporting function and acts primarily as an air separator at the periphery of the diaphragm 111. The double spider design linearizes the restoring forces produced from the spiders 114, 115 by improving the stability of the voice coil system 110 and, accordingly, reducing the off-axis voice coil system movement. Thus the voice coil system rubs and buzzes caused by the voice coil system 110 hitting the magnet system 101 are reduced.

The two spiders 114, 115 are preferably identical and arranged back-to-back in axial distance from each other. This double spider design improves the harmonic distortion due to the back-to-back configuration of each spider, evening out the difference in positive to negative excursion non-linearities. The double spider configuration reduces the DC bias associated with most loudspeakers due to suspension creep and component aging effect, which cause the surround 120 (suspension) to relax when exercised at high excursions for long times and when used at high temperature and high relative humidities.

In the present example, the two spiders 114 and 115 are attached to the voice coil carrier 112. However, each may alternatively or additionally be attached to the voice coil itself and/or the diaphragm 111, or other materials commonly used for spiders are applicable as the case may be. From the front side, an aluminum dome 121 covers the opening in the rear end of the diaphragm 111 where the voice coil system 110 is fastened.

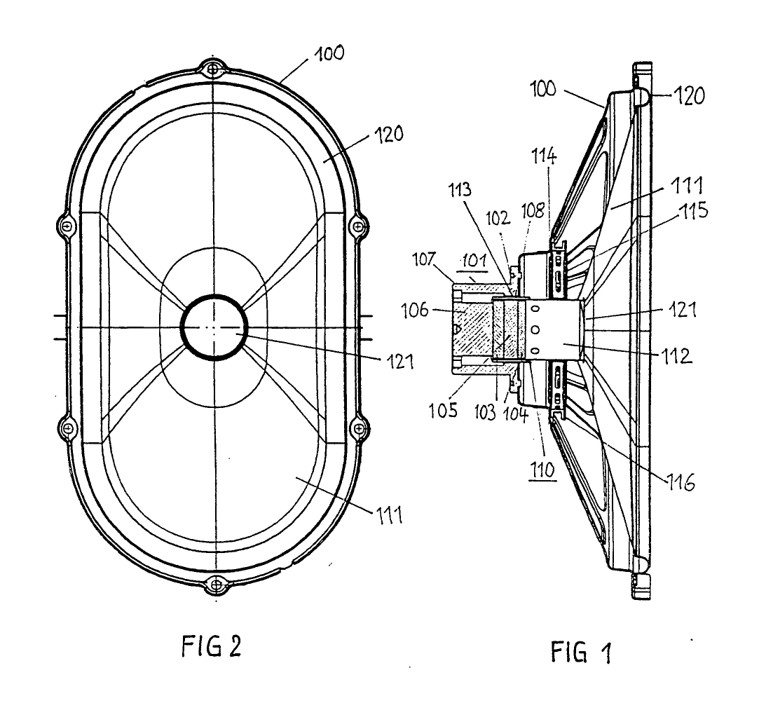

FIG. 2 is a front view of the loudspeaker of FIG. 1 illustrating the shape of diaphragm 111. The periphery of the diaphragm 111 and, accordingly, the surround 120 have a racetrack shape that has two parallel linear sides and two opposite half circles between both ends of the parallel sides.

The racetrack shape allows a loudspeaker to be placed in a location or in an enclosure where there is limited space in one direction but ample space in the other direction (e.g., where two loudspeakers are arranged side by side in a single enclosure). By linking the two loudspeakers together a greater usable cone area is employed because the wasted area next to each cone is now converted into a moving diaphragm.

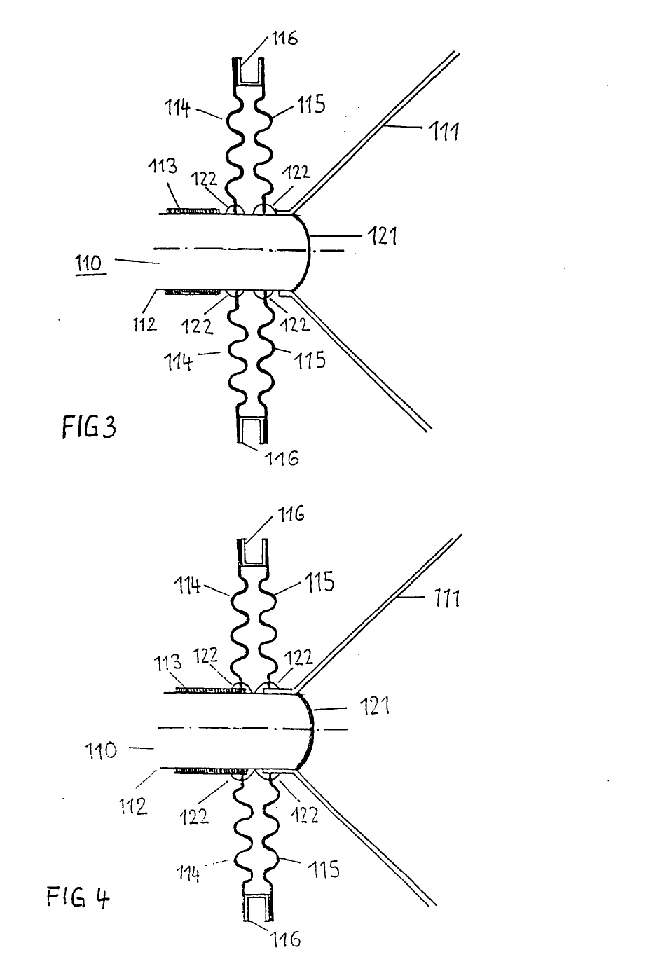

FIG. 3 is a detailed vertical sectional view of the centering system used in FIG. 1 with the two parallel spiders 114 and 115 fastened to the voice coil system 110. The spiders 114 and 115 are made from resin reinforced woven fabric and are corrugated to achieve high radial rigidity and high axial flexibility. As can be seen from FIG. 3, the corrugations of the two spiders 114, 115 are inverse to each other due to their back-to-back arrangement. Inverse corrugations imply that, in neutral position, if the one spider 114 makes a right turn the other spider 115 makes a corresponding left turn and vice versa. The outer (front) peripheries of the spiders 114 and 115 are fastened to the respective one of the end faces of the spacer ring 116 for example by adhesive. The inner (rear) peripheries of the spiders 114 and 115 are fastened by adhesive drops 122 to the voice coil carrier 112 in a distance from each other being equal to the height of the spacer ring 116. The diaphragm 111 is attached to the voice coil carrier 112 as described above. FIG. 4 is an alternative for the centering system of FIG. 3 with the two parallel spiders 114 and 115 attached to the voice coil 113 and the diaphragm 111.

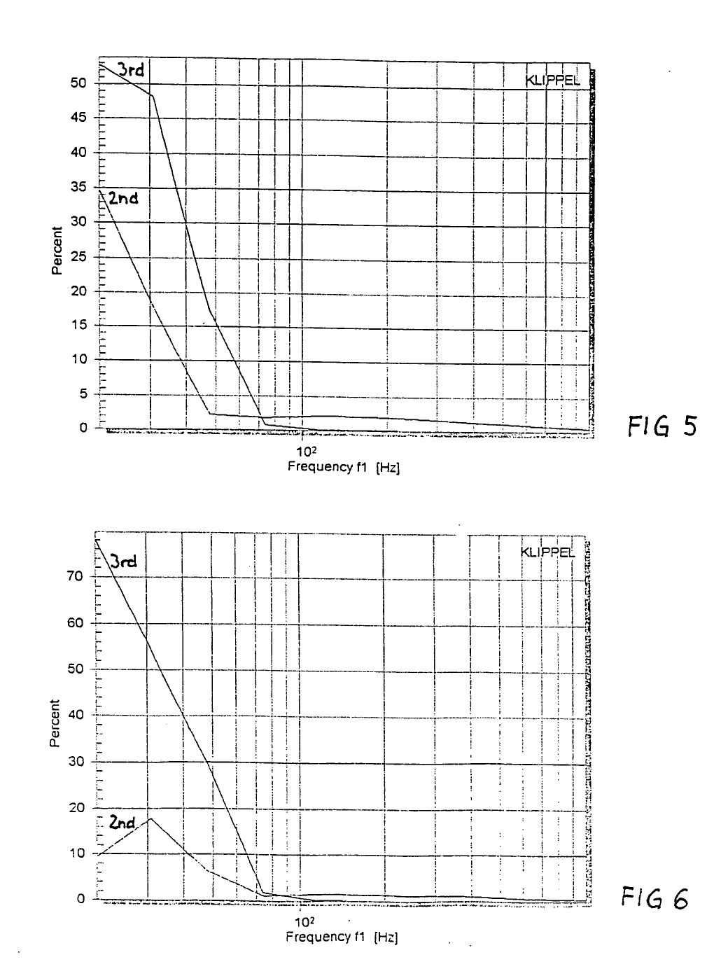

FIGS. 5 and 6 show the 2nd and 3rd harmonic distortions for a loudspeaker with a single spider (FIG. 5) and for a loudspeaker with a double spider (FIG. 6) when considering only the loudspeaker nonlinearities from the suspension compliance, spider and surround. FIGS. 5 and 6 illustrate the effect that a double spider according to the invention has over a single spider design. The graphs shown are test results (2nd and 3rd harmonic distortion in % vs. frequency in Hz) from actual prototype loudspeaker builds that have been measured on the Klippel distortion analyzer system. All of the components for these prototype builds are identical, the only difference between each loudspeaker are the number of spiders used. Either a single spider or a double spider positioned back-to-back was used for this measurement.

Referring still to FIGS. 5 and 6, the level of second (2nd) harmonic distortion with the double spider design is reduced considerably particularly around 30 Hz. This reduction in second harmonic distortion is due to the back-to-back spider configuration evening out the non-linearities of the positive and negative excursion related distortion to make them more symmetrical.

This improvement in the second harmonic distortion is evident in the acoustic measurements, therefore compounding the benefit of using a double spider design for improved low frequency distortion level, particularly for use with sub woofer loudspeakers.

As described above, a preferred loudspeaker may use a conventional loudspeaker design where the double neodymium magnet and shell pot form the motor system, which is attached to the metal chassis (serving as a frame). An aluminum cone and dome is used with a rubber surround, and an aluminum flat wire voice coil is used to increase the force factor within the motor system. The double spider design is also used to linearize the restoring forces produced from the spider components.

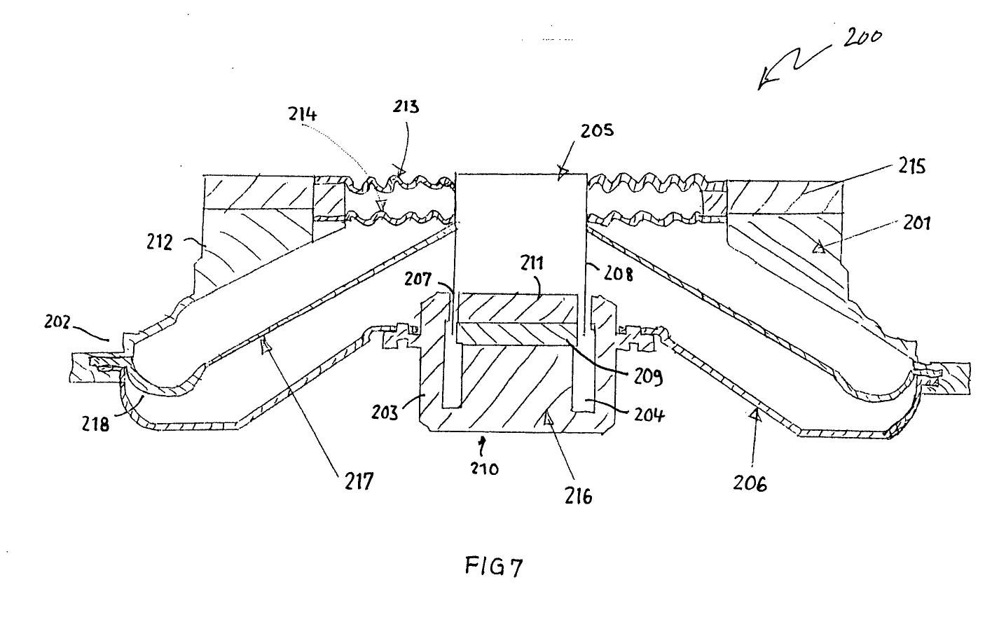

FIG. 7 is a sectional view of a flat loudspeaker having a double spider centering system 200 and an inverted magnet loudspeaker design. The loudspeaker includes a frame, for example a plastic or metal basket 201, with a front portion 202 covered by a circular cradle 206 and supporting a rearwardly opening cup-shaped front pole piece 203 formed with an annular recess 204 for accommodating the front edge of a voice coil system 205 wherein the pole piece 203 is rearwardly attached to the cradle 206. A voice coil 207 is supported on a carrier 208 (e.g., an axial slit cylindrical aluminum sheet). The voice coil system 205 comprises the voice coil 207 and the carrier 208.

A neodymium circular disk magnet 209 is sandwiched between closed end 210 of the front pole piece 203 and circular disk rear pole plate 211 coacting with the front cup-shaped pole piece 203 to define an annular gap for accommodating the voice coil system 205 with a radial magnetic field developed between the rear pole plate 211 and the cylindrical wall of the front pole piece 203. The voice coil system 205, the disk magnet 209, the front pole piece 203 and the rear pole plate 211 form a motor system 216. The cone-shaped cradle 206 is carrying in its center the front pole piece 203 and accordingly the motor system 216.

The flat loudspeaker 200 comprises two spiders 213 and 214, for example two annular elements that resiliently support the rear edge of the voice coil system 205. The two spiders 213 and 214 are arranged back-to-back in axial distance from each other and are attached on their inner end to the voice coil carrier 208 and on their outer end to a spider carrier 215. The spider carrier 215 is bonded to the rear portion of the basket 201.

A cone-shaped diaphragm 217 is attached at its center to the voice coil carrier 208 and in its outer circumference to the front portion of the basket 201 via a rubber surround 218. The diaphragm 217 may be made of aluminum, paper, plastics, or composites thereof.

A preferred embodiment of the flat loudspeaker may use an inverted magnet loudspeaker design where the double neodymium magnet and shell pot form the motor system, which is attached to the basket (frame) by a cradle. A cone-shaped diaphragm may be used with a rubber surround, and an aluminum flat wire voice coil may be used to increase the force factor within the motor system.

In particular with flat loudspeakers (e.g., inverted magnet loudspeakers), the double spider design is used to avoid tumbling of the diaphragm which is, in contrast to conventional cone loudspeakers, relatively flat and therefore tends to tumble. The double spider design improves the harmonic distortions due to the back-to-back configuration of the spiders and linearizes the restoring forces produced from the spider components.

The illustrations have been discussed with reference to functional blocks identified as modules and components that are not intended to represent discrete structures and may be combined or further sub-divided. In addition, while various embodiments of the invention have been described, it will be apparent to those of ordinary skill in the art that other embodiments and implementations are possible that are within the scope of this invention. Accordingly, the invention is not restricted except in light of the attached claims and their equivalents.

1. A loudspeaker comprising:
a frame;
a diaphragm disposed in said frame;
a motor system for said diaphragm including a magnet system attached to the frame and a voice coil system attached to the diaphragm; and
a centering system in said frame for said diaphragm and/or said voice coil and providing support therefore, said centering system including at least two spiders arranged back-to-back in axial distance from each other.

2. The loudspeaker of claim 1 wherein said diaphragm has an outer circumferential shape of a racetrack.

3. The loudspeaker of claim 1 wherein said diaphragm is made from aluminum.

4. The loudspeaker of claim 1 wherein said spiders are made from woven fabric.

5. The loudspeaker of claim 1 comprising a rubber surround connected to said diaphragm and said frame.

6. The loudspeaker of claim 1 wherein said voice coil system comprises a voice coil and a voice coil carrier.

7. The loudspeaker of claim 6 wherein said voice coil system comprises a flat wire voice coil.

8. The loudspeaker of claim 6 wherein said voice coil is made from aluminum wire.

9. The loudspeaker of claim 6 wherein at least one of said spiders is attached to said voice coil.

10. The loudspeaker of claim 6 wherein at least one of said spiders is attached to said voice coil carrier.

11. The loudspeaker of claim 1 wherein at least one of said spiders is attached to the diaphragm.

12. The loudspeaker of claim 1 wherein said diaphragm is cone-shaped.

13. The loudspeaker of claim 1 wherein said frame comprises a metal chassis.

14. The loudspeaker of claim 1 wherein the magnet system comprises at least one neodymium magnet.

15. The loudspeaker of claim 1 wherein said spiders are corrugated.

16. The loudspeaker of claim 1 wherein said spiders are attached to the frame via a spacer ring, said spacer ring has at least two faces each attached to the periphery of the respective spider.

17. The loudspeaker of claim 16 wherein said spiders are arranged parallel to each other.

18. The loudspeaker of claim 17 wherein an aluminum dome is attached to the center of the diaphragm and/or the voice coil carrier.

19. The loudspeaker of claim 1 wherein the membrane has a front side and a rear side and wherein the motor system and the centering system are arranged on the rear side of the diaphragm.

20. The loudspeaker of claim 1 wherein the membrane has a front side and a rear side and wherein the motor system is arranged on the front side of the diaphragm and the centering system is arranged on the rear side of the diaphragm.

21. The loudspeaker of claim 20 wherein said centering system is attached to the frame via a double spider carrier.

22. The loudspeaker of claim 21 wherein the motor system is attached to the frame via a cradle.

23. The loudspeaker of claim 20 wherein said voice coil system comprises a voice coil and a voice coil carrier: said voice coil carrier is arranged on the front side of the diaphragm and extends beyond the rear side of the diaphragm; said centering system is attached to the portion of the voice coil carrier extending beyond the diaphragm.
